(19) United States
(12) Patent Application Publication
(10) Pub. No.: US 2007/0148617 A1
(43) Pub. Date: Jun. 28, 2007

(54) Dental scaler

(76) Inventors: Pal-Hyung Lee, Busan (KR); Hye-Jung Lee, Busan (KR); Jae-Heon Lee, Busan (KR)

Correspondence Address: IPLA P.A., 3580 WILSHIRE BLVD., 17TH FLOOR, LOS ANGELES, CA, 90010, US

(21) Appl. No.: 10/595,652

(22) PCT Filed: Oct. 30, 2004
(86) PCT No.: PCT/KR04/02780

§ 371 Date: May 2, 2006

(30) Foreign Application Priority Data
Nov. 3, 2003 (KR) 10-2003-0077408

(51) Int. Cl. A61C 1/07

(52) U.S. Cl. 433/118

(57) ABSTRACT

Disclosed herein is a dental scaler for removing accumulated deposits from the teeth, having a low manufacturing cost so as to be widely used at home. The dental scaler includes a first casing adapted to serve a grip; a power supply-receiving section and a motor installed at the inside of a first casing serving as a grip, wherein the power supply-receiving section is adapted to contain a power supply device therein and a rotating speed of the motor is adjustable by a first switch. A vibrator is eccentrically installed at a driving shaft of the motor to be selectively in electrical contact with a second switch for connecting or disconnecting a power of an electromagnet An electromagnet-receiving section is formed at the front end portion of the first casing, for containing the electromagnet therein.

### TECHNICAL FIELD

The present invention relates to dental scalers for removing tartar from the teeth, and more particularly to a dental scaler which is manufactured at a low cost so as to be widely used at home.

### BACKGROUND ART

Generally, calculus accumulated around the teeth is removed by a dentist through a high-priced dental scaler using ultrasonic vibration. However, people can't frequently remove tartar from their teeth because they must devote their busy time to see a dentist and dental treatment for scaling the teeth costs much.

For such a dental scaler using ultrasonic vibration, since its manufacturing cost is very high, it is difficult to be widely used.

### DISCLOSURE OF INVENTION

Therefore, the present invention has been made in view of the above problem, and it is an object of the present invention to provide a low-priced dental scaler which can be widely used to remove tartar from the teeth by connecting and disconnecting a power to an electromagnet at a high speed and utilizing minute high-speed vibration caused by a magnetic force of the electromagnet.

### BRIEF DESCRIPTION OF DRAWINGS

Further objects and advantages of the invention can be more fully understood from the following detailed description taken in conjunction with the accompanying drawings in which:

FIG. 1 is a cross-sectional view of a dental scaler according to a preferred embodiment of the present invention;

FIG. 2 is an enlarged cross-sectional view showing a disassembled state of one essential part of the dental scaler according to the present invention; and

FIG. 3 is an enlarged cross-sectional view showing another preferred embodiment of one essential part of the dental scalar according to the present invention.

### BEST MODE FOR CARRYING OUT THE INVENTION

The present invention will now be described in detail in connection with preferred embodiments with reference to the accompanying drawings.

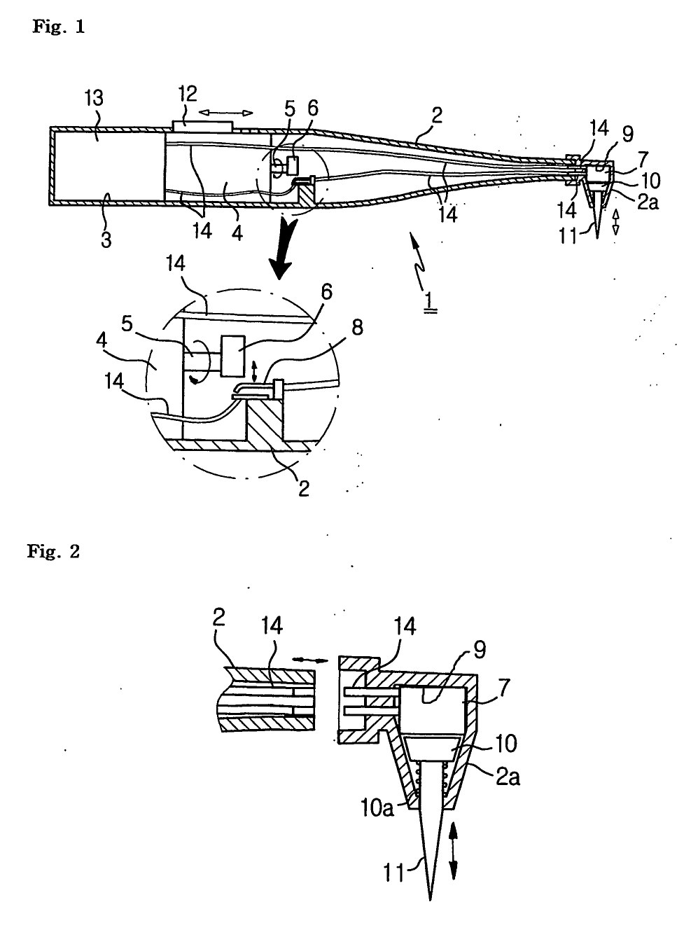

Referring to FIGS. 1 and 2, a dental scaler 1 includes a power supply-receiving section 3 for containing a power supply device, for example, a battery is formed at the inside of a casing 2 serving as a grip. A motor 4 is installed at the front of the power supply-receiving section 3.

An vibrator 6 installed eccentrically at a driving shaft 5 of the motor 4 is selectively in electrical contact with a switch 8 for connecting or disconnecting a power of an electromagnet 7.

An electromagnet-receiving section 9 for containing the electromagnet 7 is formed at the front end portion of the casing 2 and makes a right angle with the casing 2. A permanent magnet 10 with the same polarity as that of electromagnet 7 is installed at the bottom of the electromagnet 7 so that it is repelled by the magnetic force of the electromagnet 7. Depending on whether the power of the electromagnet 7 is switched on or off, the electromagnet 7 repels the permanent magnet 10 or the permanent magnet 10 is moved upwards toward the electromagnet 7 by the resilient recovery force of a spring 10a, thereby generating vibration.

A scaler tip 11 made of stainless alloy etc. is integrally formed at the bottom of the permanent magnet 10 and minutely vibrates upwards and downwards together with the permanent magnet 10.

It should be, of course, noted that although the permanent magnet 10 is replaced with a metal piece (not shown) which electrically responds to the magnetic force of the electromagnet 7 so as to move downwards by the resilience of the spring 10a, the same function is obtained and a modified embodiment will be easily designed alternatively.

Meanwhile, a switch 12 for switching on and off the power of the motor 4 is installed at the outer surface of the casing 2. It is preferable to use the switch 12 which can control the speed of the motor 4 by a resistance value.

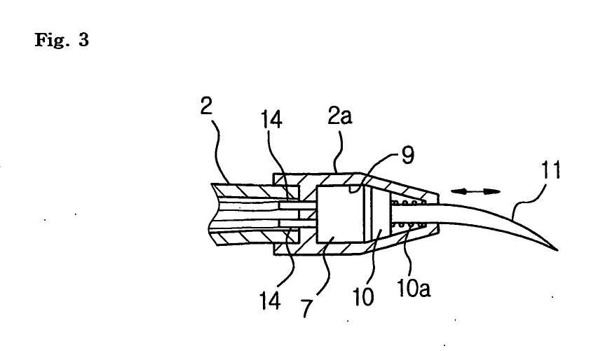

The electromagnet 7, the permanent magnet 10, and the scaler tip 11 which is integrally formed with the permanent magnet 10 are assembled at the front portion of the casing 2 by an additional casing 2a so that it is easy to replace the scaler tip 11 with a new one when it is worn down. The casing 2a may be constructed in the same length direction as that of the casing 2 as shown in FIG. 3.

Reference number 13 indicates a battery or a rechargeable condenser, and 14 designates a power cable.

In using the above-described dental scaler 1 for scaling the teeth, if a user switches the power of the motor 4 on by using the switch 12 while holding the casing 2, the motor 4 is driven to rotate the vibrator 6 installed eccentrically at the driving shaft 5 and the switch 8 within the rotating radius of the vibrator 6 is continuously turned on and off. Therefore, the power of the electromagnet 7 is turned on and off. Then the electromagnet 7 repels the permanent magnet 10 which in turn is moved upwards toward the electromagnet 7 by the resilient recovery force of the spring 10a. By such consecutive operations, the permanent magnet 10 vibrates. The vibration of the permanent magnet 10 is transmitted to the scaler tip 11 to easily remove calculus from the teeth by a minute high-speed vibration.

### INDUSTRIAL APPLICABILITY

As described above, the vibrator 6 driven by the motor 4 switches on and off the switch 8 at a high speed and the minute high-speed vibration generated by the consecutively repelling and attracting operations between the electromagnet 7 and the permanent magnet 10 is transmitted to the scaler tip 11 so as to remove tartar from the teeth. Since it is possible to provide a low-priced dental scaler for wide use, it is greatly helpful to people's dental health.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A dental scaler, comprising:
a first casing adapted to serve a grip;
a power supply-receiving section and a motor installed at the inside of the first casing, the power supply-receiving section being adapted to contain a power supply device therein and the motor having a rotating speed adjustable by a first switch;
a vibrator installed eccentrically at a driving shaft of the motor to be selectively in electrical contact with a second switch for connecting or disconnecting a power of an electromagnet;
an electromagnet-receiving section formed at the front end portion of the first casing, and adapted to contain the electromagnet therein; and
a permanent magnet installed below the electromagnet to move upwards by the resilience of a spring, the permanent magnet being formed integrally with a scaler tip.

2. The dental scaler as claimed in claim 1, further comprising a second casing installed at the front side of the first casing so that the electromagnet, the permanent magnet and the scaler tip can be detachable from the first casing.
